(19) United States
(12) Patent Application Publication
(10) Pub. No.: US 2005/0035054 A1
(43) Pub. Date: Feb. 17, 2005

(54) Skincare device for filtering tapwater

(76) Inventor: Yi-Chin Chu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/638,413

(22) Filed: Aug. 12, 2003

(51) Int. Cl. B01D 35/00

(52) U.S. Cl. 210/449; 210/460; 137/801

(57) ABSTRACT

A skincare device for filtering tapwater includes a filter having an outlet, a housing in which the filter is received, a casing having an upper casing and a lower casing, and a manifold. The upper casing is coupled to an outlet end of a faucet. The lower casing includes a water outlet that is directly below the outlet end of the faucet. The manifold is mounted in the casing and includes an upper branch for guiding tapwater from the outlet end of the faucet into the filter. The manifold further includes a lower branch for guiding filtered water from the outlet of the filter to the water outlet of the casing.

### BACKGROUND OF THE INVENTION

1. Field of the Invention

The present invention relates to a skincare device mounted to a faucet for filtering tapwater with which a human body would come into contact.

2. Description of the Related Art

Germs, impurities, organic materials, inorganic materials, chlorine, etc are contained in the flow path for tapwater, e.g., in the pipeline from the water source to a tapwater factory in the pipeline from the tapwater factory to a faucet of a house. The tapwater is generally boiled or purified before drinking. However, the tapwater for shower, bath, or washing is scarcely treated. As a result, germs, impurities, and/or heavy metal may remain in the hair, teeth, or skin of a human body.

FIGS. 1 and 2 of the drawings illustrate a conventional skincare device for purifying tapwater with which the human body would come into contact. The skincare device 1 includes a coupler 12 coupled to a faucet 6 of a house. Water from the faucet 6 flows through a filter 11 and is thus filtered or purified before use. However, the filtered or purified water flows out of the skincare device from a position below the filter 11 and spaced from the outlet of the faucet in the horizontal direction, which is inconvenient to the user even if the filter 11 is moved to a position shown by the phantom lines in FIG. 2. Further, adjustment of the position of the filter 11 is limited.

### SUMMARY OF THE INVENTION

An object of the present invention is to provide a skincare device that can be mounted to a desired position according to the user's need.

Another object of the present invention is to provide a skincare device that can be mounted to a faucet without adversely affecting use. This object is achieved by means of arranging the water outlet of the skincare device in a position directly below the outlet of the faucet.

In an embodiment of the invention, a skincare device for filtering tapwater includes a filter having an outlet, a housing in which the filter is received, a casing having an upper casing and a lower casing, and a manifold. The upper casing is coupled to an outlet end of a faucet. The lower casing includes a water outlet that is directly below the outlet end of the faucet. The manifold is mounted in the casing and includes an upper branch for guiding tapwater from the outlet end of the faucet into the filter. The manifold further includes a lower branch for guiding filtered water from the outlet of the filter to the water outlet of the casing.

Other objects, advantages, and novel features of the invention will become more apparent from the following detailed description when taken in conjunction with the accompanying drawings.

### BRIEF DESCRIPTION OF THE DRAWINGS

FIG. 1 is a sectional view of a conventional skincare device.

FIG. 2 is a perspective view of the conventional skincare device.

FIG. 3 is an exploded perspective view of a skincare device in accordance with the present invention.

FIG. 4 is a perspective view of the skincare device in accordance with the present invention.

FIG. 5 is a sectional view of the skincare device in accordance with the present invention.

FIG. 6 is a perspective view of a manifold of the skincare device in accordance with the present invention.

FIG. 7 is a side view of the manifold.

FIG. 8 is a sectional view similar to FIG. 5, illustrating operation of the skincare device in accordance with the present invention.

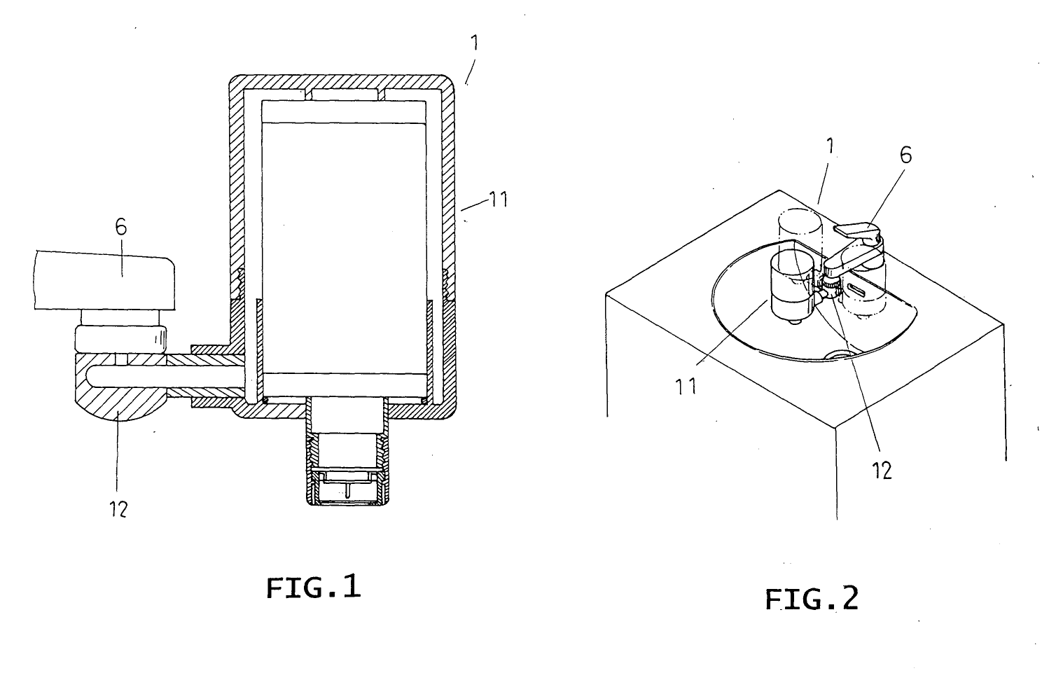

### DETAILED DESCRIPTION OF THE PREFERRED EMBODIMENT

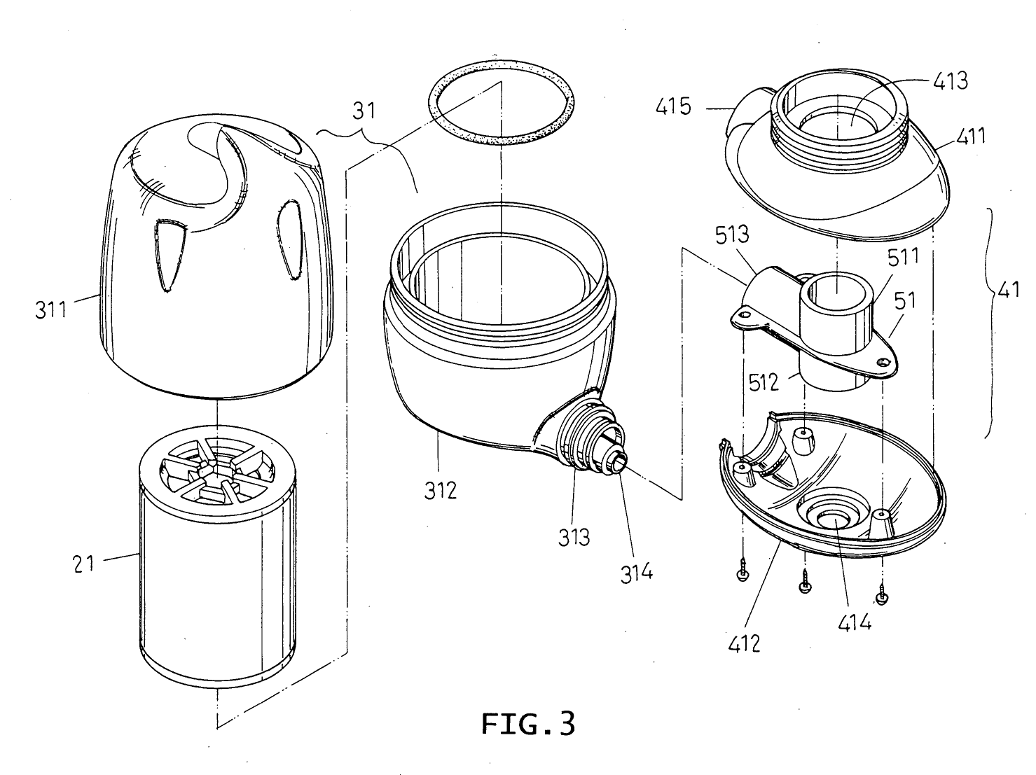

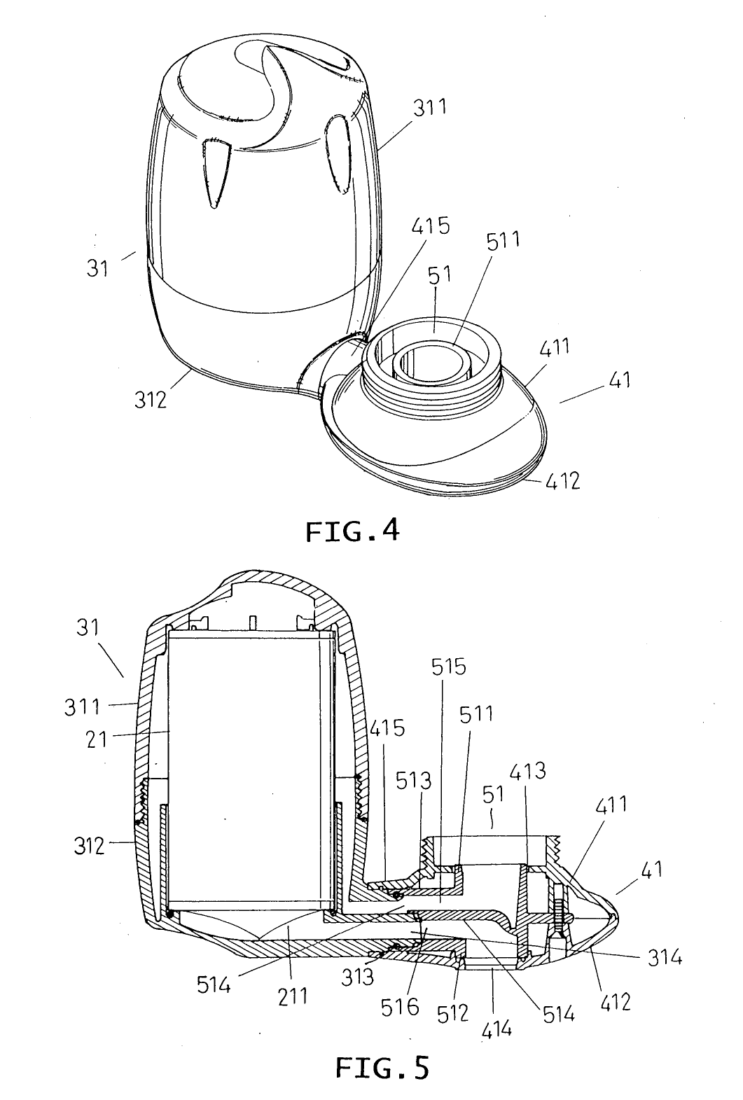

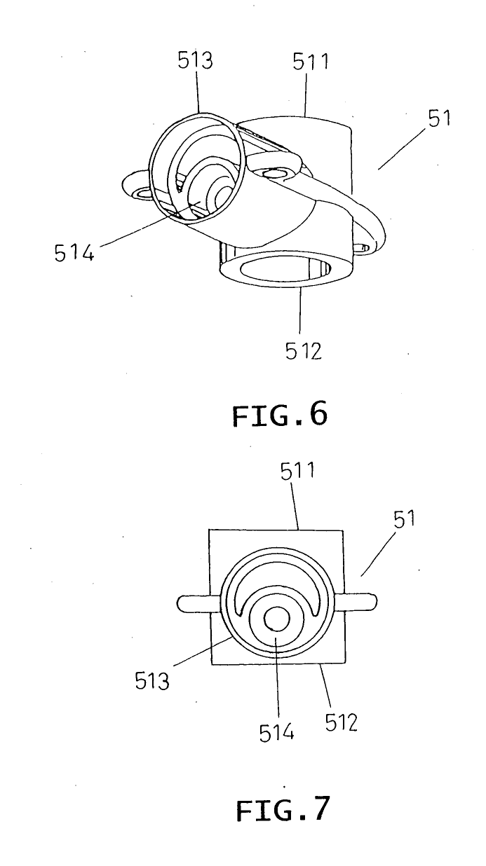

A preferred embodiment of a skincare device in accordance with the present invention will now be described with reference to the accompanying drawings. FIG. 3 is an exploded perspective view of the skincare device in accordance with the present invention. FIG. 4 is a perspective view of the skincare device. FIG. 5 is a sectional view of the skincare device. FIG. 6 is a perspective view of a manifold of the skincare device. FIG. 7 is a side view of the manifold.

As illustrated FIGS. 3 through 5, the skincare device in accordance with the present invention generally comprises a filter 21, a housing 31 for receiving the filter 21, a casing 31 attached to a side of the housing 31, and a manifold 51 mounted in the casing 31 for guiding tapwater.

The filter 21 includes a filtering means mounted therein for proceeding with filtration of tapwater from a faucet of a house or the like. The filtering means may be selected according to need. The filter 21 includes an outlet 211 in a bottom thereof. Filtered water exits the filter 21 via the outlet 211.

The housing 31 is mounted outside the filter 21 and includes an upper housing 311 and a lower housing 312. The housing 31 defines a portion of a water inlet passage 515 communicated with an inlet (not shown) of the filter 21. In this embodiment, the lower housing 312 includes a tube 313 formed on a side thereof. Further, an inner tube 314 is formed inside the tube 313 and communicated with the outlet 211 of the filter 21, providing a water outlet passage for filtered or purified water. Further, the tube 313 is communicated with the inlet of the filter 21, providing a portion of a water inlet passage 515.

Referring to FIGS. 3 through 5, the casing 41 includes an upper casing 411 and a lower casing 412. A hole 413 is defined in a top of the upper casing 411, and a water outlet 414 is defined in a bottom of the lower casing 412. A side tube 415 extends from the casing 41 and coupled to the tube 313 of the housing 31.

Referring to FIGS. 3 through 7, the manifold 51 is mounted in the casing 41 and includes an upper branch 512, a lower branch 513, and a side branch 513. The upper branch 511 extends in the upper casing 411 and through the hole 413 of the upper casing 411. It is noted that the upper branch 511 forms a portion of the water inlet passage 515 and communicated with the portion of the water inlet passage in the housing. The lower branch 511 extends in the lower casing 412 and forms a water outlet passage 516 that is communicated with the inner tube 314, which, in turn, is communicated with the outlet 211 of the filter 21. Further, the water outlet passage 516 is communicated with the water outlet 414 in the bottom of the lower casing 412.

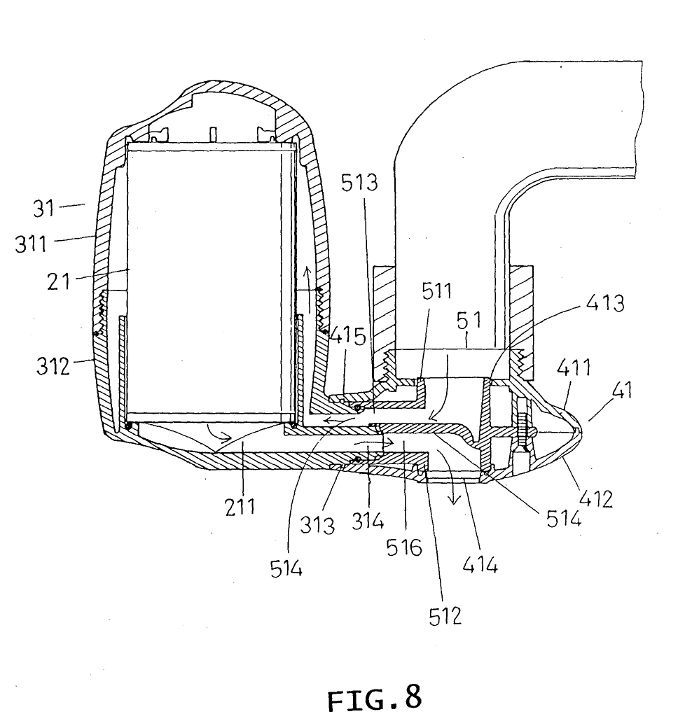

As illustrated in FIG. 8, the upper casing 411 is coupled to an outlet end (not labeled) of a faucet (not labeled). Thus, the water outlet 414 that is directly below the hole 413 of the casing 41 is directly below an outlet of the faucet, thereby not interfering with use of the filtered or purified water. As indicated by the arrows in FIG. 8, tapwater (or water) flows out of the outlet of the faucet and enters the filter 21 via the water inlet passage 515. Filtered or purified water flows through the outlet 211 of the filter 21 and the water outlet passage 516 and exits the casing 41 via the water outlet 414 for use. The user may adjust the position of the skincare device without changing the position of the water outlet 414 that is always located below the outlet of the faucet.

Although the invention has been explained in relation to its preferred embodiment, it is to be understood that many other possible modifications and variations can be made without departing from the scope of the invention as hereinafter claimed.

1. A skincare device for filtering tapwater, comprising:
a filter including an outlet;
a housing in which the filter is received,
a casing including an upper casing and a lower casing, the upper casing being adapted to be coupled to an outlet end of a faucet, the lower casing including a water outlet that is directly below the outlet end of the faucet; and
a manifold mounted in the casing and including an upper branch for guiding tapwater from the outlet end of the faucet into the filter, the manifold further including a lower branch for guiding filtered water from the outlet of the filter to the water outlet of the casing.

2. The skincare device as claimed in claim 1, wherein the housing includes an upper housing and a lower housing, the lower housing including a tube formed on a side thereof and communicated with the upper branch of the manifold, an inner tube being defined in the tube of the lower housing and communicated with the lower branch of the manifold.

3. The skincare device as claimed in claim 2, wherein the casing further includes a side branch coupled to the tube of the lower housing.
